(19) United States
(12) Patent Application Publication
(10) Pub. No.: US 2016/0055507 A1
(43) Pub. Date: Feb. 25, 2016

(54) FORECASTING MARKET PRICES FOR MANAGEMENT OF GRID-SCALE ENERGY STORAGE SYSTEMS

(71) Applicant: NEC Laboratories America, Inc., Princeton, NJ (US)

(72) Inventors: Rakesh Patil, San Francisco, CA (US); Ratnesh Sharma, Fremont, CA (US)

(21) Appl. No.: 14/831,650

(22) Filed: Aug. 20, 2015

Related U.S. Application Data
(60) Provisional application No. 62/039,946, filed on Aug. 21, 2014.

(51) Int. Cl. G06Q 30/02; G06F 17/50

(52) U.S. Cl. CPC G06Q 30/0206; G06Q 30/0203; G06F 17/5009; G06Q 50/06

(57) ABSTRACT

Systems and methods for forecasting energy usage data for one or more markets, including providing energy variable input data for one or more energy variables, transforming the energy variable input data using functions of the energy variable input data to generate transformed functions, modeling the transformed functions as one or more time series models, the time series models representing energy usage over time and energy usage predictions, and generating forecasted energy usage data based on the one or more time series models for management of one or more energy resources.

### RELATED APPLICATION INFORMATION

This application claims priority to provisional application number 62/039,946 filed Aug. 21, 2014, the contents of which are incorporated herein by reference.

### BACKGROUND OF THE INVENTION

1. Technical Field

The present invention relates generally to management of grid-scale Energy Storage Systems (ESSs), and more particularly, to a system and method for forecasting market prices for participation in energy markets and management of grid-scale ESSs.

2. Description of the Related Art

Grid-connected energy storage systems (ESSs) are a fast growing global market. Recently, increases in the penetration of renewable energy resources into grid-connected ESSs have presented a challenge to the traditional design and operation of electric power systems. The existing power grid was designed for centralized power generation with unidirectional power flow. With renewable energy (or any other type of distributed generation of electricity), power is effectively generated everywhere and flows in multiple directions. However, the intermittent and highly variable nature of distributed generation causes power quality and/or reliability issues, which leads to increased energy costs.

Research on forecasting electricity prices has focused on techniques including employment of neural networks, principle component analysis, averaged Monte Carlo simulations, and time series modeling. Although these methods have been applied to obtain price forecasts, the focus of these methods is simply to improve forecasting quality through improved model fitting, and processing costs and the practical application of the forecasting information are not considered. Furthermore, these conventional forecasting methods also require large amounts of data (e.g., several months, years, etc.) for forecasting of electricity prices. Moreover, this forecasting is not employed for participation in energy markets.

Locational Marginal Price (LMP) is an indicator of the costs of providing uninterrupted electric power at a particular location (e.g., node) in an electric grid. LMP is a factor of supply-demand costs, congestion costs, and network constraints, and is determined on a day-ahead basis and/or in real-time. Depending on the prices bid by a power dispatching resource (e.g., battery, generator, etc.) and the LMP calculated by, for example, an Independent System Operator (ISO), the day-ahead energy market is cleared (e.g., clearing market bids for one or more markets (e.g., energy, reserves, etc.)), and a similar approach is in place by most ISOs to buy/sell power for frequency regulation using regulation prices. These prices are difficult to determine before the market clears since they are dependent on a variety of factors in the electric grid as well as the physics of the electric grid.

### SUMMARY

A computer implemented method for forecasting energy usage data for one or more markets, including providing energy variable input data for one or more energy variables, transforming the energy variable input data using functions of the energy variable input data to generate transformed functions, modeling the transformed functions as one or more time series models, the time series models representing energy usage over time and energy usage predictions, and generating forecasted energy usage data based on the one or more time series models for management of one or more energy storage systems (ESSs)

A system for management of one or more energy storage systems (ESSs), including a forecaster for predicting energy usage data for one or more markets, the forecasting being further configured to provide energy variable input data for one or more energy variables, transform the energy variable input data using functions of the energy variable input data to generate transformed functions, model the transformed functions as one or more time series models, the time series models representing energy usage over time and energy usage predictions, and generate forecasted energy usage data based on the one or more time s series models. A controller applies the forecasted energy usage data for the management of the one or more energy storage systems (ESSs).

A computer-readable storage medium including a computer-readable program, wherein the computer-readable program when executed on a computer causes the computer to perform the steps of providing energy variable input data for one or more energy variables, transforming the energy variable input data using functions of the energy variable input data to generate transformed functions, modeling the transformed functions as one or more time series models, the time series models representing energy usage over time and energy usage predictions, and generating forecasted energy usage data based on the one or more time series models for management of one or more energy storage systems (ESSs)

These and other advantages of the invention will be apparent to those of ordinary skill in the art by reference to the following detailed description and the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles;

FIG. 2 shows an exemplary method for forecasting energy usage and/or market prices for participation in energy markets and management of grid-scale Energy Storage Systems (ESSs), in accordance with an embodiment of the present principles;

FIG. 3 shows an exemplary high-level method for forecasting market prices, in accordance with an embodiment of the present principles;

FIG. 4 shows an exemplary method for forecasting market prices for participation in energy markets and management of grid-scale Energy Storage Systems (ESSs), in accordance with an embodiment of the present principles; and

FIG. 5 shows an exemplary system for forecasting energy usage and/or market prices for participation in energy markets and management of grid-scale Energy Storage Systems (ESSs), in accordance with an embodiment of the present principles.

### DETAILED DESCRIPTION OF PREFERRED EMBODIMENTS

The present principles are directed to systems and methods for forecasting energy usage data (e.g., market prices) for participation in energy markets and management of grid-scale ESSs according to various embodiments.

In an embodiment, a time series based market price forecasting engine may be employed according to the present principles. A plurality of model inputs (e.g., load forecasts, load variations on the price forecast quality, etc.), and the resulting forecasts may be employed to generated bids and to participate in energy markets (e.g., day-ahead, hour-by-hour, second-by-second, etc.) using a minimal amount of data and computational costs for the forecasting according to the present principles.

In a particularly useful embodiment, dynamic rules (as opposed to static rules which remain the same every day) to participate in the market may be generated using the forecasts to maximize revenue generation in the energy market, and the use of dynamic rules may enable participation in multiple markets simultaneously according to the present principles. In an embodiment, time series based forecasts are generated using minimal computational costs (e.g., because a small amount of data may be employed because of the use of modified functions of the inputs (e.g., including logarithm of the electric load, derivative of the electric load, sign of the derivative of the historical price signal, etc.), and the forecasts are fast (e.g., order of seconds) since they are time-series based.

Prices in different electricity markets (e.g., energy, FR, etc.) are known only after energy bids clear, and as such, the price forecasting engine according the present principles may be employed to participate in markets optimally. In an embodiment, the price forecasting may be performed using a small amount of data (e.g., days) with low computational effort, and may include a time series based forecasting method because this method is computationally fast and may allow for the inclusion of exogenous inputs (e.g., load, local temperature, constraints on electric transmission (if known)). These exogenous inputs may then be modified to produce more exogenous input signals according to some embodiments. Forecasted prices may be employed in conjunction with a battery degradation cost to, for example, schedule Grid Scale Storage (GSS) for participation in multiple energy markets according to various embodiments. In addition, a novel voltage regulation method for use in GSS may advantageously be employed according to some embodiments.

In an embodiment, optimization of dispatching energy resources (e.g., ESSs, batteries, diesel power and controllable loads, etc.) may be performed based on the forecasted prices. The goal of the dispatch may be to meet reserves, participate in energy and/or frequency regulation markets etc. and to maintain system reliability.

It should be understood that embodiments described herein may be entirely hardware or may include both hardware and software elements, which includes but is not limited to firmware, resident software, microcode, etc. In a preferred embodiment, the present invention is implemented in hardware. The present invention may be a system, a method, and/or a computer program product. The computer program product may include a computer readable storage medium (or media) having computer readable program instructions thereon for causing a processor to carry out aspects of the present invention.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

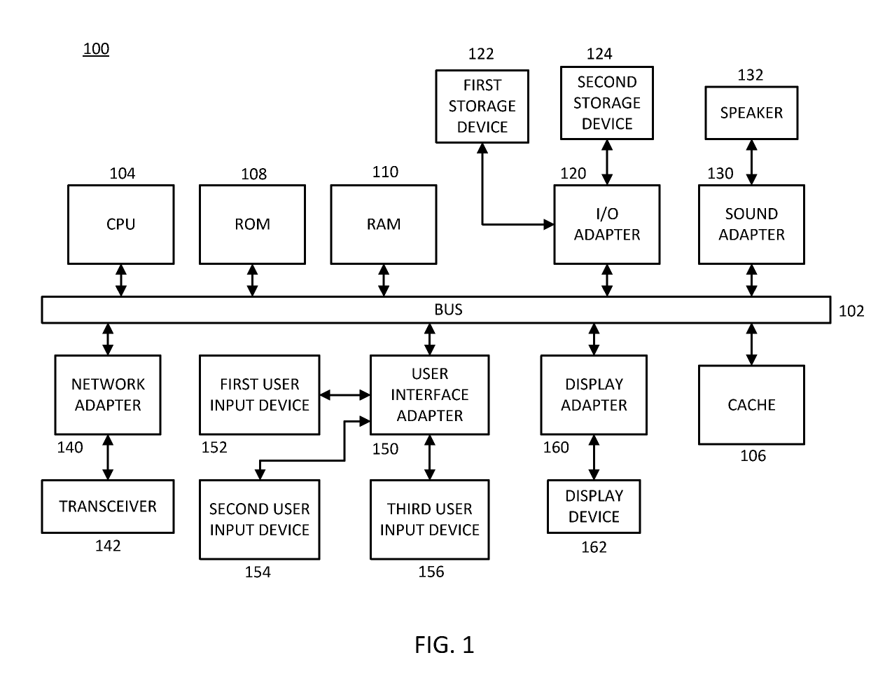

Referring now to the drawings in which like numerals represent the same or similar elements and initially to FIG. 1, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

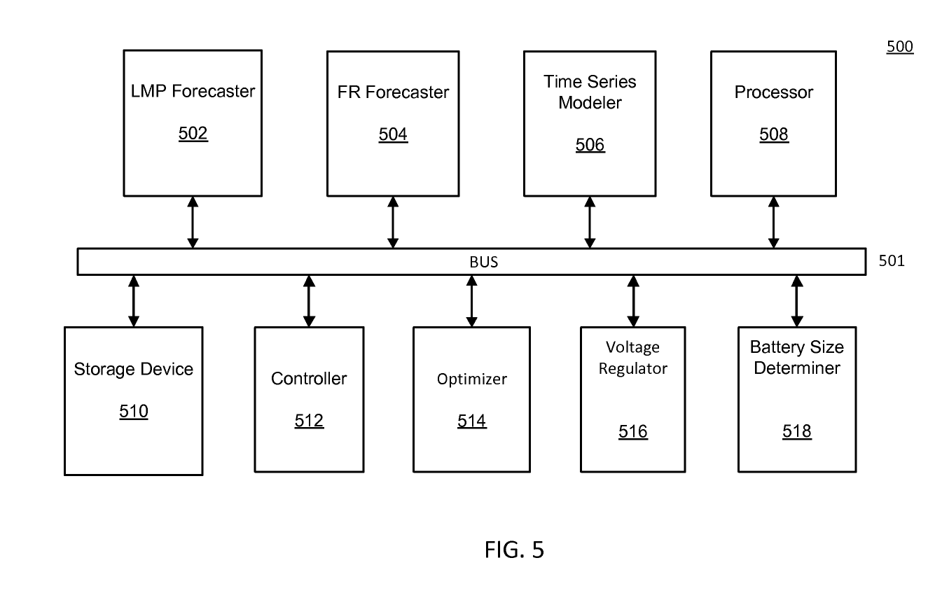

Moreover, it is to be appreciated that system 500 described below with respect to FIG. 5, is a system for implementing respective embodiments of the present principles. Part or all of processing system 100 may be implemented in one or more of the elements of system 500.

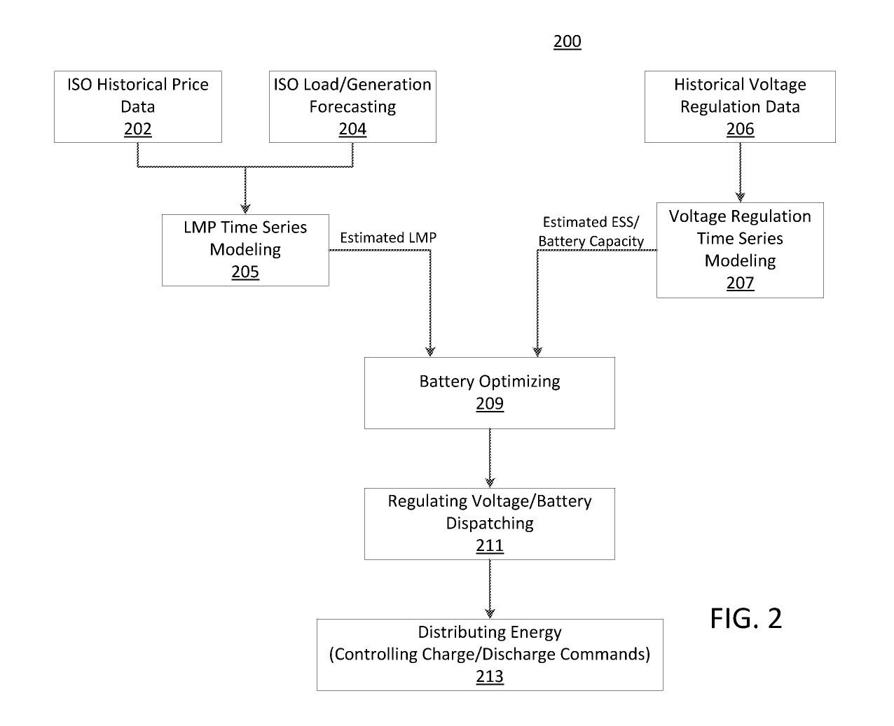

Further, it is to be appreciated that processing system 100 may perform at least part of the method described herein including, for example, at least part of methods 200, 300, and 400 of FIGS. 2, 3, and 4, respectively. Similarly, part or all of system 500 may be used to perform at least part of methods 200, 300, and 400 of FIGS. 2, 3, and 4, respectively.

Referring now to FIG. 2, an exemplary method 200 for forecasting energy usage and/or market prices for participation in energy markets and management of grid-scale Energy Storage Systems (ESSs) is illustratively depicted in accordance with an embodiment of the present principles. In an embodiment, the method 200 may be employed to determine an optimal Grid Scale Storage (GSS) schedules to participate in, for example, day-ahead energy and Frequency Regulation (FR) markets, and to control voltage regulation and distribution services in real-time. A plurality of parameters related to energy market, network, and/or GSS operations may be measured of received according to various embodiments, and may be employed as input for an GSS management method 200 according to the present principles.

To participate in energy markets, users of GSS units may submit energy bids to market operators prior to the beginning of each day. Thus, the method 200 may determine optimal bids (e.g., energy demands; requirements; requests; etc.) by, for example, performing optimization with dynamic constraints in block 209 for the next day according to various embodiments. These bids may be based on, for example, forecasted market prices from block 205 and/or 207 and/or estimated reserve capacity for voltage regulation operation according to various embodiments of the present principles.

In an embodiment, historical Independent System Operator (ISO) price data 202, historical and/or forecasted load and/or generation profiles/data 204 (e.g., for the next day for day-ahead markets) may be employed as input for time series modeling (e.g., Locational Marginal Price (LMP) time series modeling) in block 205 to forecast/predict market prices according to the present principles. In an embodiment, a time series based method (e.g., Auto Regressive Moving Average with eXogeneous inputs (ARMAX), Auto-Regressive eXogeneous (ARX), etc.) may be employed for forecasting day-ahead electricity market prices in blocks 205 and 207. The time series modeling in blocks 205 and 207 will be discussed in further detail herein below.

In an embodiment, historical voltage profiles and voltage regulation requirements (e.g., at the point of GSS connection to the energy grid) 206 may be employed as input for time series modeling (e.g., Voltage Regulation (VR) time series modeling) in block 207 to determine (e.g., estimate) the necessary (or desired) FSS capacity for voltage regulation during each hour of the next day. The VR time series modeling 206 will be described in further detail herein below.

In an embodiment, the estimated LMP from block 205 and the estimated GSS/battery capacity (e.g., voltage regulation capacity) from block 207 may be employed as input for performing GSS/battery co-optimization with dynamic constraints using an optimizer in block 209. In an embodiment, GSS/battery cost and operation limits 208 may also be employed as input into an optimizer for performing optimization in block 209. The optimization in block 209 may, for example, generate optimal GSS bids for day-ahead market operation based on the time series modeling in block 310, and the bids may be submitted (e.g., daily) to one or more market operators according to an embodiment of the present principles.

In an embodiment, after an optimal GSS schedule for market operation is generated by the optimizer in block 209, the generated schedule may be employed for voltage regulation and/or GSS dispatching in block 211 In block 213, commands may be sent to the GSS unit to control participation in the voltage regulation market by controlling distribution of energy in block 218 according to an embodiment of the present principles.

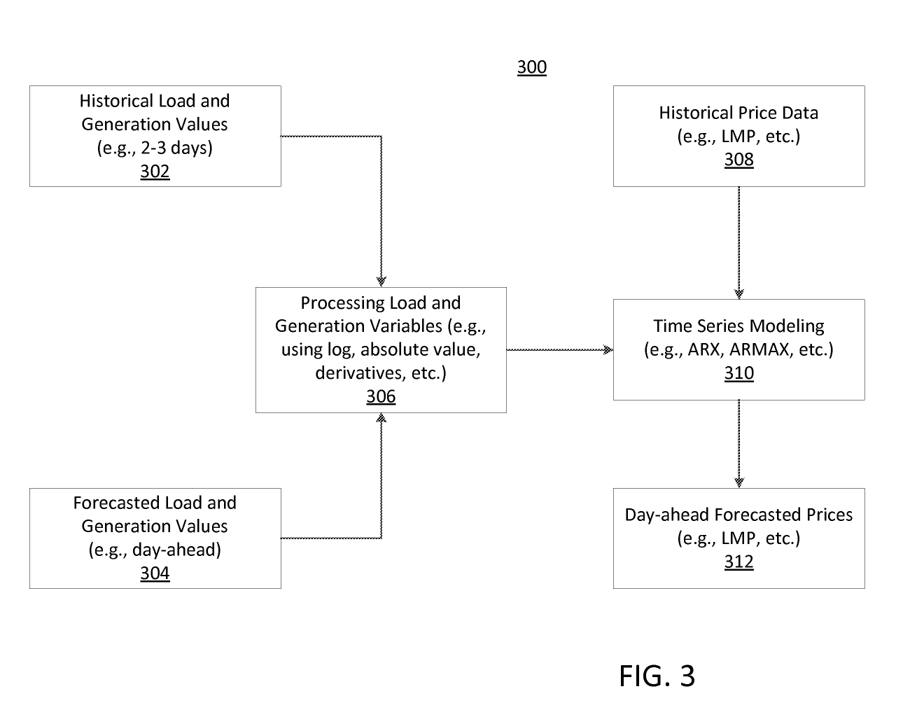

Referring now to FIG. 3, an exemplary high-level method 300 for forecasting is illustratively depicted in accordance with an embodiment of the present principles. In an embodiment, the method 300 may employ two steps for forecasting market prices (e.g., day-ahead electricity market prices). The first step may include processing inputs, including, historical load and/or generation values (e.g., 2-3 days) from block 302, forecasted load and/or generation values (e.g., 2-3 days) from block 304, and historical price data (e.g., LMP, etc.) from block 308. Although the above-mentioned inputs are illustratively depicted for simplicity, it is contemplated that any inputs may also be employed according to various embodiments of the present principles.

In an embodiment, inputs (e.g., 302, 304) may be processed using various functions to obtain the actual input signals to the models (e.g., ARMAX models) in block 306, and the inputs 302, 304 may be referred to collectively as energy variable input data. The energy variable input data may include, for example, price, energy demand, temperature, location, etc. according to various embodiments.

In an embodiment, the particular function choice for processing load and/or generation variables (e.g., using log, absolute value, derivatives, etc.) in block 306 may be dependent on the particular price that is to be forecasted (e.g., predicted). For example, LMP is highly dependent on the load forecasts from block 304 and the times at which the load forecast reaches maximum and minimum values (which may be determined through derivatives). In an embodiment, to forecast frequency regulation prices, functions such as absolute value may be employed in block 306 for processing (e.g., processing load and generation variables) according to the present principles.

In an embodiment, the inputs processed in block 306 may be employed as input for the time series modeling (e.g., time series forecasting/predicting) in block 310. An illustrative example of a time series model (e.g., Auto Regressive Moving Average with eXogenous inputs (ARMAX)) according to an embodiment may be represented by the following:

P(t+1)=a₁P(t)+a₂P(t−1)+a₃P(t−2)+b₁ P̅(t)+b₂ P̅(t−1)+c₁X(t)+c₂X(t−1)+ε(t), (1)

where P is a price (e.g., LMP, frequency regulation price), and P̅ is a moving average considering a fixed number of steps back. The price forecast (P(t+1)) may also be a function of the past (e.g., historical) values of exogenous inputs (e.g., X(t), (X(t−1)) according to the present principles.

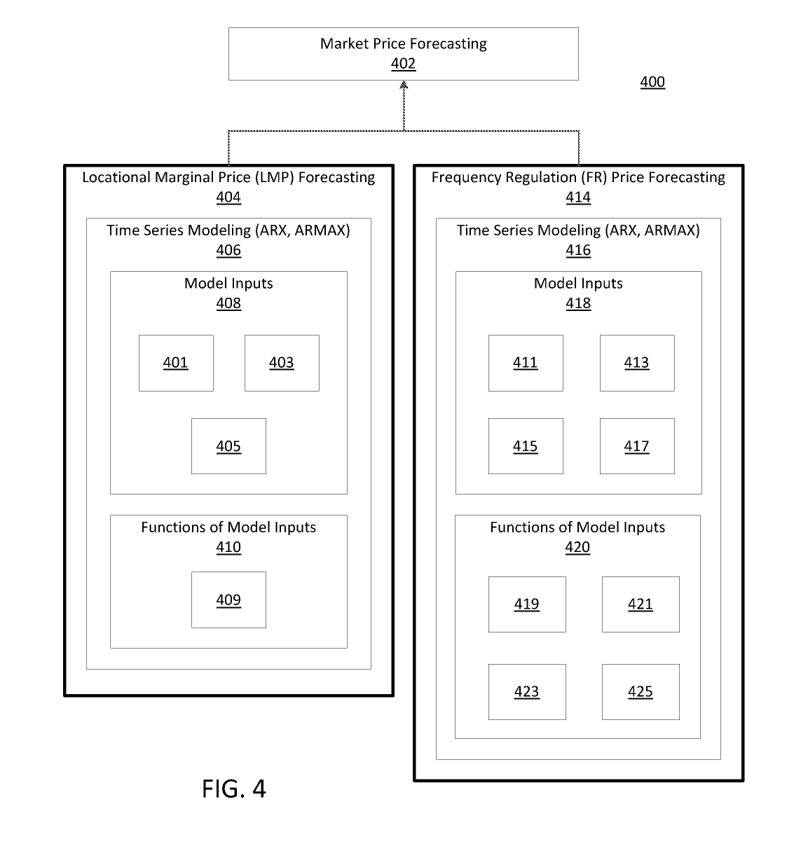

In an embodiment, unique exogenous inputs, which may be functions of historical values of load and generation variables 302 and/or functions of load forecasts 304 may be employed during time series modeling (e.g., ARX, ARMAX, etc.) in block 310 to generate forecasted prices (e.g., day-ahead forecasted prices) in block 312 according to the present principles. The use of the functions of past measured values of load and generation variables 302 and/or functions of load forecasts 304 as unique exogenous inputs rather than the measured values themselves enables lower processing costs during forecasting (e.g., by pre-processing of the historical values of load and generation variables 302 and/or functions of load forecasts 304) according to an embodiment. The pre-processing may capture more information than directly feeding in signals (e.g., load forecasts), which results in a need for less data (e.g., a few days rather than months or years (as required by conventional systems)), and hence less computational processing time and memory usage. The forecasting will be described in further detail herein below with reference to FIG. 4.

In an embodiment, inputs (e.g., past price data, load data, load and generation forecasts for the day-ahead, etc.) to block 306 may be processed to transform the inputs (e.g., transform into simplified functions of the inputs) to generate functions of the inputs for use in time series based modeling in block 310. The inputs to the time series block may be functions of the inputs mentioned above, and the particular function choice is dependent on the price that is to be forecasted. Forecasting by processing the inputs in block 306 to generate functions of the inputs for use in time series modeling in block 310 enables the use of small amounts of data (e.g., days, hours, etc.) to provide accurate forecasts for a plurality of prices according to various embodiments of the present principles.

It is noted that although forecasting day-ahead prices is illustratively depicted for simplicity of illustration, it is contemplated that the present principles may be employed for forecasting (e.g., predicting) other prices (e.g., hour-by-hour, second-by-second, etc.) according to various embodiments.

Referring now to FIG. 4, with continued reference to FIG. 3, an exemplary method 400 for forecasting market prices is illustratively depicted in accordance with an embodiment of the present principles. In accordance with embodiments of the present principles, locational marginal price (LMP) forecasting 404 and/or frequency regulation (FR) price forecasting 414 may be employed for market price forecasting/predicting (e.g., electricity market price forecasting/predicting) in block 402. In various embodiments, the forecasting 402 may be employed to, for example, distribute energy, generate bids for energy markets, frequency regulation markets as shown, regulate voltage, and/or determine optimal battery (e.g., GSS battery) size and/or battery life, etc. according to various embodiments of the present principles.

For simplicity of illustration, embodiments of the present principles will be described with respect to day-ahead energy markets, but the present principles may be employed for predicting/forecasting prices for any types of markets according to various embodiments.

In an embodiment, LMP forecasting 404 may be employed to predict/forecast prices for markets (e.g., day-ahead electricity markets) using time series modeling in block 406 (e.g., time series modeling as described above with reference to FIG. 3, block 310 and equation (1)). The time series modeling in block 406 may be performed using unique model inputs 408, including, for example, historical price data 401, historical load data 403, and/or forecasted load data 405 according to various embodiments of the present principles.

In an embodiment, the inputs 401, 403, and 405 may be processed in block 410 to generate functions of the model inputs, including, for example, logarithm and/or exponential functions 409 (e.g., log and exponential of load and derivatives of the load). In various embodiments, the inputs 401, 403, and 405 and/or the functions 409 may be employed as inputs (e.g., exogenous inputs) for price forecasting in block 402 using, for example, time series modeling (e.g., ARX, ARMAX) in block 406. In an embodiment, exogenous inputs which are functions of a plurality of measurements may be employed as inputs for forecasting in block 402.

In block 416, time series modeling (e.g., ARX, ARMAX) may be employed for forecasting FR prices (e.g., in day-ahead energy markets) in block 414 according to the present principles. Similarly to the LMP forecasting in block 404, the FR price forecasting 414 may employ unique inputs and/or functions of the inputs for time series modeling in block 416 according to various embodiments. For FR forecasting in block 414, different functions may be employed in the time series modeling (e.g., in comparison to the LMP forecasting in block 404), as frequency regulation prices may have a dissimilar trend (e.g., sharper jumps in trends than LMPs). In various embodiments, the time series modeling 406, 416 may be performed for a plurality of different periods of time (e.g., minutes, hours, days, etc.) according to the present principles.

In an embodiment, model inputs 418 for time series modeling in block 416 may include historical price data 411, historical load data 413, load forecast data 415 (e.g., load forecasted by the ISO for the next day for a particular location), and/or generation forecast data 417 according to the present principles. In an embodiment, to process sharper jumps in FR price trends (e.g., in comparison to LMP price trends), different functions of the model inputs 418 than are employed for LMP forecasting 404 may be employed in block 420. In various embodiments, the functions of model inputs 418 that are processed in block 420 may include, for example, derivatives/double derivatives 419, logarithm and/or exponential functions 421 (e.g., log and exponential of load and derivatives of the load), sign and/or absolute value functions 423, and/or products of one or more of the functions 425 (e.g., 419, 421, and/or 423).

In an embodiment, the processing of the inputs to generate functions of the model inputs in blocks 410 and 420 may be employed to forecast market prices with a small amount of data (e.g., minutes, hours, days, etc) according to the present principles. Functions of inputs in blocks 410 and 420 (e.g., their derivative, log, exponential, absolute value, sign and the products of such functions of the inputs) may be employed to capture trends in prices for price forecasting in block 402. For example, the LMP time series modeling 406 may be strongly dependent on the trend of the load forecast, however at the peak loads the LMP may be determined by using the trend of the derivatives of the load in block 409, which enables the use of a small amount of data (e.g., 2-3 days) for the price forecasting/predicting in block 402.

Referring now to FIG. 5, with continued reference to FIGS. 3 and 4, an exemplary system 500 for forecasting market prices for participation in energy markets and management of grid-scale Energy Storage Systems (ESSs) is illustratively depicted in accordance with an embodiment of the present principles.

The system 500 may include an LMP forecaster 502, an FR forecaster 504, a time series modeler 506, a processor 508, a storage device 510, a controller 512, an optimizer 514, a voltage regulator 516, and/or a battery size determiner 518 according to various embodiments of the present principles.

While many aspects of system 500 are described in singular form for the sakes of illustration and clarity, the same can be applied to multiples ones of the items mentioned with respect to the description of system 500. For example, while a single storage device 510 is described, more than one storage device 510 can be used in accordance with the teachings of the present principles, while maintaining the spirit of the present principles. Moreover, it is appreciated that the storage device 510 is but one aspect involved with system 500 than can be extended to plural form while maintaining the spirit of the present principles.

In an embodiment, a controller 512 may be employed for optimal dispatch of energy resources (e.g., batteries, diesel power, solar generation, controllable loads and/or automated power injection for voltage regulation) based on the output of the forecasters 502, 504 and the time series modeler 506 in accordance with the present principles.

In an embodiment, a voltage regulator 516 may be employed for voltage regulation (e.g., to control the real and reactive power injection at a point of common coupling (PCC) by dispatching GSSs. A controller 512 may be employed for controlling the optimizer 514 and/or for determining and submitting bids (e.g., daily bids) for one or more markets (e.g., day-ahead energy markets) according to various embodiments. Independent System Operator (ISO) data may be input into the system 500, and an LMP forecaster 502 and an FR forecaster 504 may be employed for time series forecasting (e.g., ARX forecasting) to determine a profile of future ISO signals. The output of the forecasters 502, 504 may be employed as input to a battery size determiner 518 to determine an optimal battery size for a particular schedule of dispatch of energy resources (e.g., batteries, diesel power, solar generation, controllable loads and/or automated power injection for voltage regulation), and the output of the battery size determiner may be employed as input to the optimizer 514 for optimization (e.g., stochastic dispatch optimization). Stochastic optimization may evaluate a cost tradeoff of providing the ISO service vs. battery life cost for a plurality of situations to determine the optimal battery size and dispatch schedule according to the present principles. The output of the optimizer may be employed for command controlling/dispatching using the controller 512.

In an embodiment, the forecasters 502, 504 may forecast load and/or generation profiles/data for day-ahead energy markets (as described above with reference to FIG. 2), and the forecasts may be stored in a storage device 510, and may be input into a time series modeler 506 for LMP and/or voltage regulation time series modeling (as described above with reference to FIGS. 3 and 4) according to various embodiments. In an embodiment a processor 508 may be employed for processing load and/or generation variables (as described in FIG. 3, block 306) to generate input for the time series modeling in block 506 according to the present principles.

In the embodiment shown in FIG. 5, the elements thereof are interconnected by a bus 501. However, in other embodiments, other types of connections can also be used. Moreover, in an embodiment, at least one of the elements of system 500 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 500 are readily determined by one of ordinary skill in the art, given the teachings of the present principles provided herein, while maintaining the spirit of the present principles.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A computer implemented method for forecasting energy usage data for one or more markets, comprising:
providing energy variable input data for one or more energy variables;
transforming the energy variable input data using functions of the energy variable input data to generate transformed functions;
modeling the transformed functions as one or more time series models, the time series models representing energy usage over time and energy usage predictions; and
generating forecasted energy usage data based on the one or more time series models for management of one or more energy resources.

2. The method of claim 1, wherein the one or more time series models include a Locational Marginal Price (LMP) time series model and a voltage regulation time series model.

3. The method of claim 1, wherein the energy variable input data includes historical energy market price, forecasted load and generation data, and historical voltage regulation data.

4. The method of claim 1, further comprising actively controlling power to dispatch at least one of batteries, diesel power, or other localized generation and controllable loads automatically to provide a plurality of services, the services including energy, frequency and voltage regulation and improve system reliability.

5. The method of claim 1, wherein the one or more time series models are generated based on 2-3 days of historical data.

6. The method of claim 1, wherein the functions of the energy variable input data include logarithm, exponential, and derivative functions of the energy variable input data.

7. The method of claim 1, wherein the energy resources include one or more of batteries, diesel generation or other local resources, and controllable loads.

8. A system for management of one or more energy storage systems (ESSs), comprising:
a forecaster for predicting energy usage data for one or more markets, the forecasting being further configured to:
provide energy variable input data for one or more energy variables;
transform the energy variable input data using functions of the energy variable input data to generate transformed functions;
model the transformed functions as one or more time series models, the time series models representing energy usage over time and energy usage predictions; and
generate forecasted energy usage data based on the one or more time s series models; and
a controller to apply the forecasted energy usage data for the management of the one or more energy resources.

9. The system of claim 8, wherein the one or more time series models include a Locational Marginal Price (LMP) time series model and a voltage regulation time series model.

10. The system of claim 8, wherein the energy variable input data includes historical energy market price, forecasted load and generation data, and historical voltage regulation data.

11. The system of claim 8, wherein the energy resources include one or more of batteries, diesel generation or other local resources, and controllable loads.

12. The system of claim 8, wherein the one or more time series models are generated based on 2-3 days of historical data.

13. The system of claim 8, wherein the functions of the energy variable input data include logarithm, exponential, and derivative functions of the energy variable input data.

14. The system of claim 8, wherein the forecasted energy usage data is employed for battery size determination in one or more ESSs.

15. A computer-readable storage medium comprising a computer readable program, wherein the computer readable program when executed on a computer causes the computer to perform the steps of:
providing energy variable input data for one or more energy variables;
transforming the energy variable input data using functions of the energy variable input data to generate transformed functions;
modeling the transformed functions as one or more time series models, the time series models representing energy usage over time and energy usage predictions; and
generating forecasted energy usage data based on the one or more time series models for management of energy resources.

16. The computer-readable storage medium of claim 15, wherein the one or more time series models include a Locational Marginal Price (LMP) time series model and a voltage regulation time series model.

17. The computer-readable storage medium of claim 15, wherein the energy variable input data includes historical energy market price, forecasted load and generation data, and historical voltage regulation data.

18. The computer-readable storage medium of claim 15, further comprising actively controlling power to dispatch ESSs automatically to maintain system voltage in an ESS within a normal range.

19. The computer-readable storage medium of claim 15, wherein the one or more time series models are generated based on 2-3 days of historical data.

20. The computer-readable storage medium of claim 15, wherein the energy resources include one or more of batteries, diesel generation or other local resources, and controllable loads.
